(19) United States
(12) Patent Application Publication
(10) Pub. No.: US 2005/0039263 A1
(43) Pub. Date: Feb. 24, 2005

(54) Adjustable beds or recliners

(76) Inventors: Alexander Heathcliff Reed, Sheffield (GB); Christopher Iain Williams, Lancashire (GB); David Mark Williams, Derbyshire (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/496,738

(22) PCT Filed: Nov. 25, 2002
(86) PCT No.: PCT/GB02/05289

(30) Foreign Application Priority Data
Nov. 27, 2001 (GB) 0128301.9

(51) Int. Cl. A61G 7/015

(52) U.S. Cl. 5/618

(57) ABSTRACT

The invention relates to an adjustable bed or recliner. In both hospital/nursing home and domestic environments, the elderly, the infirm and those in poor health frequently need to rest in not only prone or sitting or reclined positions. The invention seeks to improve on constructions known hitherto, an objective met by an adjustable bed or recliner comprising at least two platforms (3,4) pivotally connected at their adjacent edges, and each pivotally connected to a support structure (11) below the platforms, the pivot between the platforms being located between the pivotal connections (17,19) to the support structure (11), and the pivot (18) between the said platforms being in fixed location on one platform (3) and in sliding engagement with the other (4), there being a mechanism (16,24) associated with a least one said platform (3) to allow it to be set at a required angular disposition with respect to the other said platform (4).

This invention relates to adjustable beds or recliners.

In hospitals and in nursing homes it is well-established that for the assistance and comfort of patients, beds and chairs can usefully be provided with adjustable sections, to allow a patient to be supported properly in a sitting, reclining or prone condition. This not only provides comfort and support on those occasions where a patient wants to be sat, reclined or laid flat, but also allows a patient to be moved periodically to assist in the prevention of the creation of pressure sores.

Outside hospital and nursing homes, there is a need in the domestic sphere to provide adjustable beds or recliners, not only for use by the elderly or the infirm, for much the same reasons as those mentioned above for hospital and nursing home patients, but also for use by the able-bodied so that they may choose to be sat, reclined, or be prone as might suit them from time to time.

With known constructions, it is generally so that a number, usually three supporting platforms are provided, with each platform in hinged engagement with an adjacent platform, there being mechanisms below the platforms and attached thereto, to allow each section to be pivoted to an appropriate and required angular disposition. Such platforms and mechanisms are more than adequate to provide as many angular dispositions as are reasonably required, but they have the problem of attempting to fold a conventional mattress laid on the support platforms. As a result, and in all dispositions other than flat, a crease or rucking of the mattress is an inevitable result of setting one platform at an angular disposition in relation to an adjacent platform.

The object of the invention is to provide an adjustable bed or recliner where those disadvantages mentioned above are substantially eliminated.

According to the present invention, an adjustable bed or recliner comprises at least two platforms pivotally connected at their adjacent edges, and each pivotally connected to a support structure below the platforms, the pivot between the platforms being located between the pivotal connections to the support structure, and the pivot between the said platforms being in fixed location on one platform and in sliding engagement with the other, there being a mechanism associated with at least one said platform to allow it to be set at a required angular disposition with respect to the other said platform.

Preferably, there is a continuous flexible form stable sheet overlying the, at least, two platforms and secured to the upper surfaces of the said platforms to either side of their pivotal connection to each other.

Thus, in the prone position, the platforms are horizontally aligned, and the pivot secured to one platform positioned at the remote end of the slot in the other platform. As the at least one platform is set at a required angular disposition, the pivotal connection between the platforms moves along the slot effectively lengthening that platform. As a result, the connections between the flexible sheet and the platforms are moved relatively towards each other, causing the sheet between the connections to assume a curved configuration, and the distance between the pivots dictating the radius of curvature of the arc.

The positions of connections of the flexible sheet to the platforms and the locations of the pivotal connections of the platforms to the support structure is not critical, but ideally, the connections of the sheet to the platforms is so located with respect to the pivotal connections to the support structure, that as a consequence, the radius of curvature of the curved portion of the flexible sheet is positioned at the neutral axis mid-point of the thickness of the sheet.

The support structure below the platforms may be static, and a lifting/lowering mechanism attached below one (torso) platform. Activation of the lifting/lowering mechanism, causes the torso platform to lift from a horizontal condition and pivot about its connection to the support structure, and the sliding and pivoting connection between that platform and the other, thigh or buttocks, platform causing it to pivot oppositely to put the two platforms at a required angular disposition, with the consequent provision of an arcuate section of flexible sheet bridging the ends of the platforms.

As a consequence, a mattress placed on the flexible sheet also assumes a smooth curved configuration across the pivotal joint between the torso and thigh platforms, free from creasing and rucking on its surface to the considerable benefit of a user of the bed or recliner.

Whilst relative movement between the platforms as is described above sets the mattress in a required position and surface condition, raising the torso platform can induce a sliding force as between the mattress and the user, that whilst relatively small can cause mild discomfort and a riding up the body of the user's outer clothing.

To avoid this, it is desirable to cause a downward and rearward movement of the pivot between the platforms as the torso platform is raised. To achieve this, the pivotal attachment of the torso platform to the support structure is set at a predetermined distance along the platform from the position of the pivotal connection to the thigh platform. Thus, pivoting of the torso platform upwardly from a prone condition, automatically causes the pivot to the thigh platform to lower and move rearwardly, with a consequent opposite pivotal movement of the thigh platform about its pivotal connection to the support structure. This causes a rotation of the user's thighs and torso about the hip joint of the user, and substantially eliminates any sliding force between the mattress and the torso of the user.

There is a further advantage to be had if the outer end of the torso platform is caused to move vertically up or down, to keep its outer edge in close proximity to a wall against which a bed or recliner can be placed. This can be achieved by causing the support platform to move as the torso platform is pivoted about its connection to the thigh platform. To allow for such movement the support structure may be mounted on slide rails, and/or may be provided with wheels. The means to move the support structure, may be a separate drive means that co-operates with and is calibrated with respect to the means to raise and lower the torso platform, such that two movement means act in tandem, to result in the support structure being moved commensurately with the raising and lowering of the torso platform.

In place of separate drive means, there may be provided towards the outer end of the torso platform, a pivotally attached link itself pivotally attached to a further support, the distances between the pivotal connection to the support structure and the pivotal connection to the link, and the length of the pivotal link being such that as the torso platform is raised and lowered, the support structure is caused to move commensurately backwards and forwards.

This arrangement causes the pivotal connection between the torso platform and the link to move rearwardly and vertically up and down, and consequently the remote end of the torso platform to move vertically up and down.

Most desirably, a bed or recliner in accordance with the invention is provided with a third platform to support the lower leg of a user below the knee. Such a third platform is preferably pivotally attached to the thigh platform, and is provided with a lifting and lowering mechanism, to set the leg platform at a required angular disposition in relation to the thigh platform. The lifting and lowering mechanism for the leg platform may be separate from the other lifting and lowering mechanisms and operated by a user as required, or may be interconnected with the other lifting and lowering mechanisms by appropriate linkages, or electrically or by suitable hydraulics, and such that a single drive means can operate all movements required of the platforms and of the support structure.

For the still further comfort of the user, the free end section of the torso platform may be hingedly connected to and angularly adjustable with respect to the remainder of the torso platform, and such that an effective head rest can be provided. Preferably, a separate moving mechanism is provided.

One embodiment of the invention will now be described with reference to the accompanying drawings, in which:—

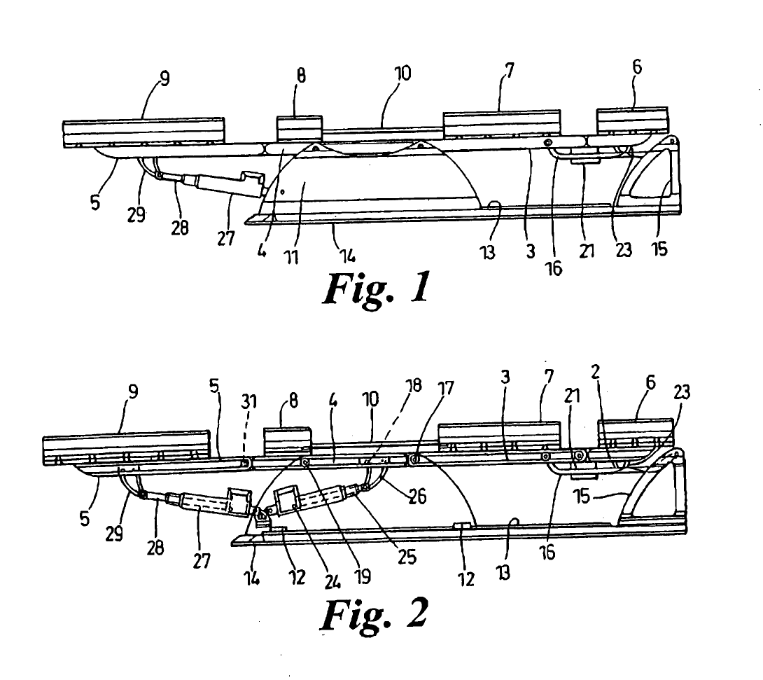

FIG. 1 is a side elevation of one embodiment of adjustable bed in accordance with the invention, in a prone condition;

FIG. 2 corresponds to FIG. 1 but has parts removed for clarity;

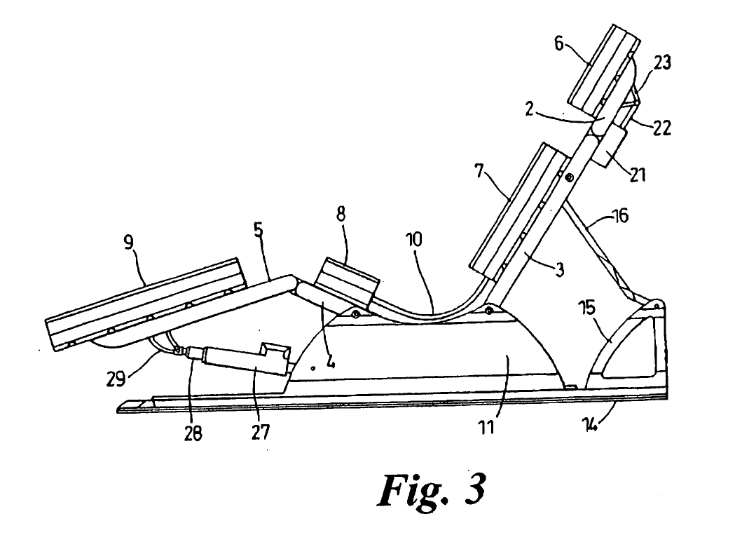

FIG. 3 corresponds to FIG. 1 but shows the bed in a recliner condition, with parts removed for clarity;

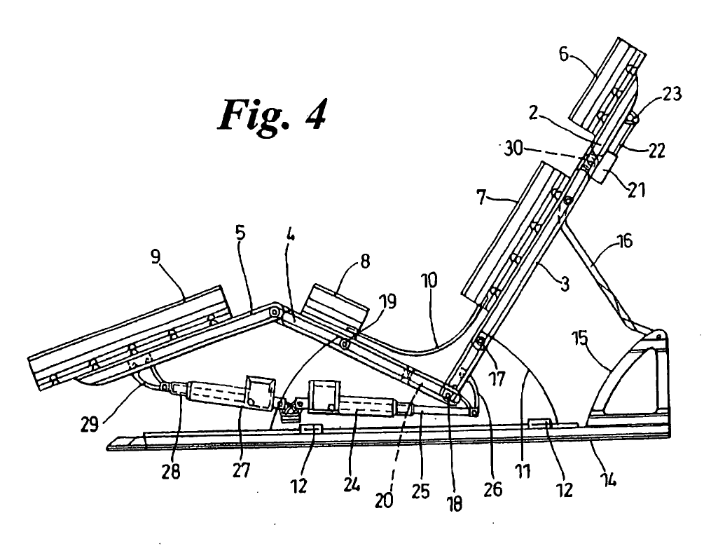

FIG. 4 corresponds to FIG. 3 but has parts removed for clarity;

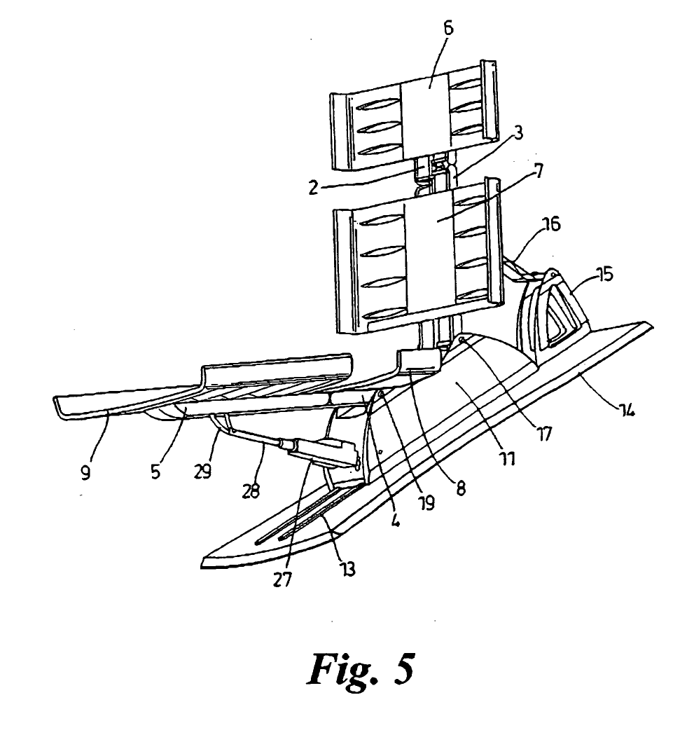

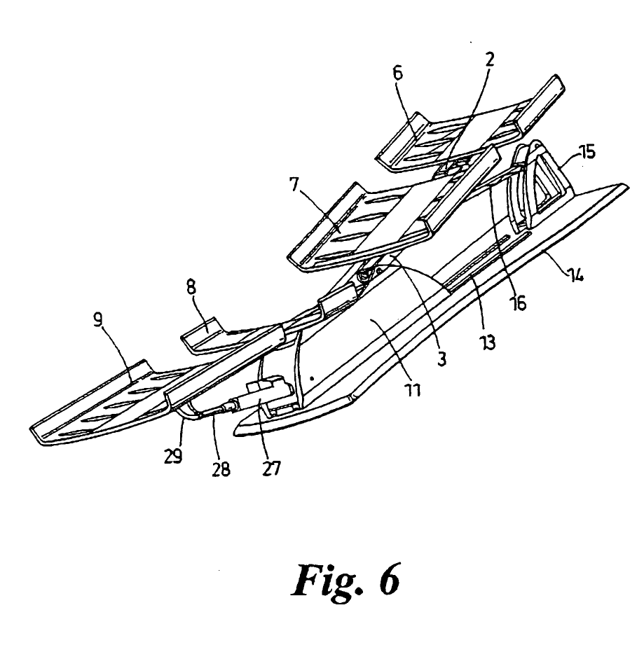

FIG. 5 and FIG. 6 are perspective views of the bed of FIG. 1 showing different dispositions of the body support parts;

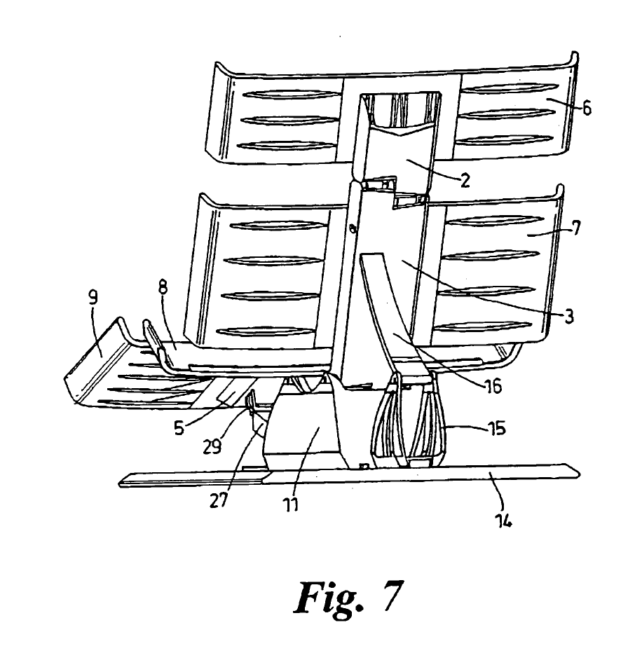

FIG. 7 is a rear perspective view of the bed of FIG. 1;

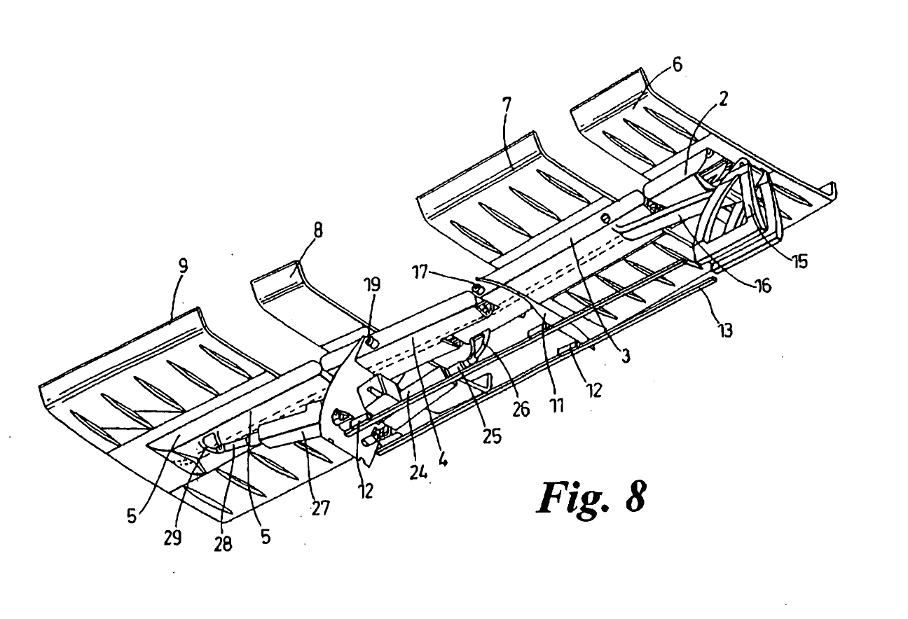

FIG. 8 is an underneath perspective view of the bed of FIG. 1, with parts removed for clarity;

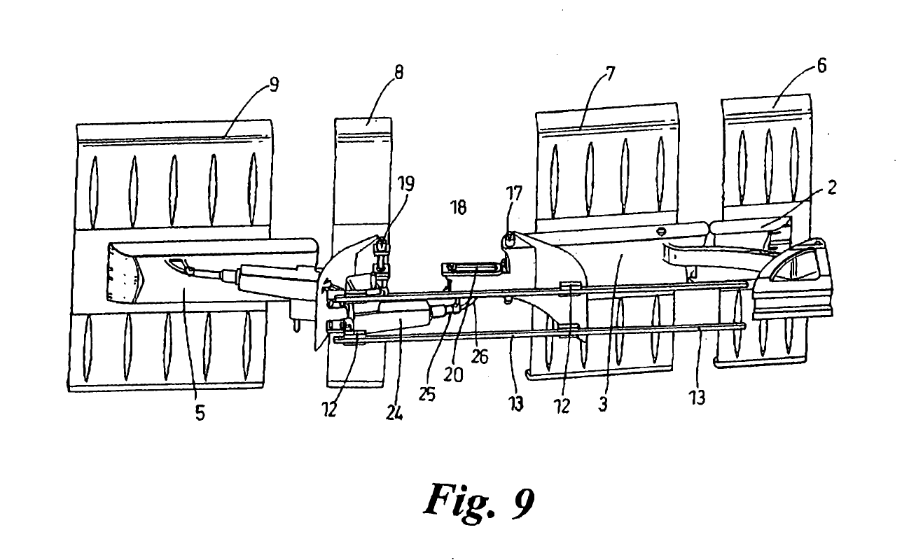

FIG. 9 corresponds to FIG. 8 with further parts removed for clarity;

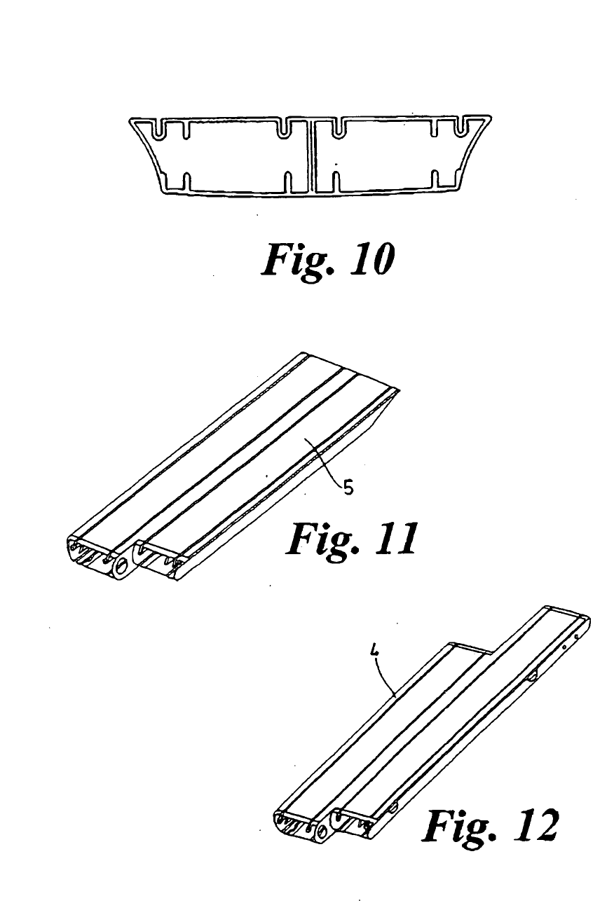

FIG. 10 is a sectional view of each of the support platforms of FIG. 1;

FIG. 11 is a perspective view of one of the body support platforms of FIG. 1; and

FIG. 12 is a perspective view of another of the support platforms of FIG. 1.

In the drawings, an adjustable bed 1 has a head platform 2, a torso platform 3, a buttocks and thigh platform 4 and a lower leg platform 5, each hingedly connected to the adjacent platform. Each platform 2 to 5 carries a respective mattress support member 6 to 9, and the mattress support members 7 for the torso and 8 for the buttocks and thighs are bridged by a flexible form stable sheet 10.

The platforms 2 to 5 are carried by a support structure or carriage 11 that has slide members 12 engaging parallel rails 13 on a base member 14.

At the head end of the bed 1, a bracket 15 is provided on which is pivotally mounted a stay 16, the opposite end of which is pivotally attached to the torso platform 3.

The torso platform is supported on the carriage 11 by a pivot 17 at a predetermined distance from its end that is pivotally attached at 18 to the buttocks and thigh platform 4, the buttocks and thigh platform also being supported on the carriage by a pivot 19.

The pivot 18 is in fixed position on the torso platform 3, but is in sliding engagement with the buttocks and thigh platform, by locating in a slot 20 towards the adjacent end of the buttocks and thigh platform (see FIG. 9).

The head platform 6 is pivotally attached to the end of the torso platform, and a drive motor 21 is provided on the torso platform, the drive rod 22 of which is pivotally attached to a bracket 23 on the head platform.

Attached to the floor of the carriage 11 is a drive motor 24, the drive rod 25 of which extends to and is pivotally attached to a bracket 26 secured to the torso platform 4. Also attached to the floor of the carriage 11 is a second drive motor 27, the drive rod of which extends to and is pivotally attached to a bracket 29 on the lower leg platform 5.

From the prone position as is illustrated in FIGS. 1 and 2, the drive motor 24 can be activated to extend its drive rod 25. A force is provided along the line of the platforms through the bracket 26, and as a consequence, a force is provided on the carriage in the direction of the head end of the bed to cause it to slide along the rails in a direction towards the head end of the bed, the result of which is that the torso platform is caused to rotate about its pivot 17, and as a consequence the stay 16 is lifted and the carriage 11 drawn towards the head end of the bed. The opposite end of the platform 5 is lowered to cause its pivot 18 to slide along the slot 20 in the buttocks and thigh platform 4 to cause it to pivot oppositely about the pivot 19 to the carriage, and to set the platforms in a required angular disposition such as in illustrated in FIGS. 3 and 4.

As a result of the compound movement of the platforms 3 and 4, the sheet 10 bridging them is caused to take up curved configuration as is illustrated in FIGS. 3 and 4, for the comfort of the user, and the rearward movement of the buttocks and thigh platform with the carriage, ensures that the torso of the user is lifted without any relative movement of the back of the user and the torso platform 3.

For the further comfort of the user or to suit a particular condition, perhaps medical, the head platform 2 is pivotally attached at 30 to the end of the torso platform 3, and the drive motor 21 can be activated to set the head platform in a required angular disposition in relation to the torso platform. Also the lower leg platform 5 is pivotally attached at 31 to the end of the buttocks and thigh platform, and activation of the drive motor 27 allows the lower leg platform to be set at a required angular disposition to the buttocks and thigh platform 4.

FIGS. 5 and 6 show a variety of dispositions of the platforms and mattress support members.

The mattress support members 6 to 9 can be of any appropriate material to combine light weight with strength and pleasing appearance, and are shaped to provide outer edges 32 to grip and secure in place a conventional or orthopaedic mattress, but preferably a mattress specifically designed to be able to articulate, that can follow all movements of the platforms 2 to 5 and support members 6 to 9.

For simplicity and economy of manufacture, the platforms 2 to 5 are all formed from an extrusion of the same cross-section as is illustrated in FIGS. 10 to 12. Each end of a length of the extrusion is machined to generate sections to accept a hinge, and to allow adjacent sections to be hinged together, the buttocks or thigh platform being machined (see FIG. 12) to provide an end piece 33 of a length to have the slot 20.

1. An adjustable bed or recliner comprising: first and second platforms pivotally connected at their adjacent edges at a pivot, and each said platform pivotally connected to a support structure below the platforms at pivotal connections, the pivot between the platforms being located between the pivotal connections to the support structure, and the pivot between the platforms being in fixed location on said and in sliding engagement with said second platform, and a mechanism associated with said first platform to allow said first platform to be set at a required angular disposition with respect to said second platform.

2. An adjustable bed or recliner as in claim 1, further including a continuous flexible form stable sheet overlying said first and second platforms and secured to upper surfaces of said platforms at connections provided at sides of said pivot.

3. An adjustable bed or recliner as in claim 2, wherein in a prone position, the platforms are horizontally aligned, and the pivot secured to said first platform is positioned at the remote end of a slot in said second platform and whereby as said first platform is set at a required angular disposition, the pivot between the platforms moves along the slot effectively lengthening said first platform, and as a result, the connections between the sheet and the platforms are moved relatively towards each other, causing the sheet to assume a curved configuration having a radius of curvature between the connections, and distances between the pivots and pivotal connections defining said radius.

4. An adjustable bed or recliner as in claim 3, wherein said sheet has a predetermined thickness the connections of the sheet to the platforms is so located with respect to the pivotal connections, that the radius of curvature of the curved configuration is positioned at a neutral axis mid-point of said thickness of the sheet.

5. An adjustable bed or recliner as in claim 1, wherein the support structure below the platforms is static, and a lifting/lowering mechanism attached below said first platform.

6. An adjustable bed or recliner as in claim 1, wherein the pivotal connection of the first platform to the support structure is set at a predetermined distance along the first platform from the position of the pivotal connection to the second platform pivoting of the first platform upwardly from a prone condition, automatically causing the pivot to the second platform to lower and move rearwardly, with a consequent opposite pivotal movement of the second platform about its pivotal connection to the support structure.

7. An adjustable bed or recliner as in claim 1, wherein the support platform is caused to move as the first platform is pivoted about said pivot.

8. An adjustable bed or recliner as in claim 7, wherein to allow for such movement the support structure is mounted on slide rails and/or provided with wheels.

9. An adjustable bed or recliner as in claim 7 or claim 8, wherein a lifting/lowering mechanism is attached below said first platform and the support structure is moved by a separate drive mechanism that co-operates with and is calibrated with respect to the lifting/lowering mechanism, such that said lifting/lowering mechanism and said drive mechanism act in tandem, to result in the support structure being moved commensurately with the raising and lowering of the first platform.

10. An adjustable bed or recliner as in claim 7 or claim 8, wherein the first platform, has a pivotally attached link at an outer end thereof to define a pivot connection, said link having a predetermined length and being pivotally attached to a support, wherein distances between the pivotal connections to the support structure and the pivot connection to the link, and the length of the link being such that as the first platform is raised and lowered, the support structure is caused to move commensurately backwards and forwards.

11. An adjustable bed or recliner as in claim 1, further including a third platform for supporting the leg of a user below the knee.

12. An adjustable bed or recliner as in claim 11, wherein the third platform is pivotally attached to the second platform, and a lifting and lowering mechanism is provided to set the third platform at a required angular disposition.

13. An adjustable bed or recliner as in claims 11 or 12 further including a fourth platform is provided, pivotally attached to the end of the first platform, and a drive mechanism provided to set the fourth platform at a required angular disposition.
